(19) United States
(12) Patent Application Publication
(10) Pub. No.: US 2014/0197059 A1
(43) Pub. Date: Jul. 17, 2014

(54) CONTAINER, TOOLBOX, AND CART

(71) Applicant: Keter Plastic Ltd., Herzliya (IL)

(72) Inventors: Richard Douglas EVANS, Rishon LeZion (IL); Oren Hetzroni, Moshav Herut (IL); Joseph Krespin, Netanya (IL)

(21) Appl. No.: 14/154,198

(22) Filed: Jan. 14, 2014

Related U.S. Application Data
(60) Provisional application No. 61/751,968, filed on Jan. 14, 2013.

(51) Int. Cl. B25H 3/02

(52) U.S. Cl. CPC B25H 3/02
USPC 206/349; 220/660

(57) ABSTRACT

A box, container, receptacle, cart, and toolbox include a bottom-side panel and four side-panels. A first side-panel includes a first reinforcement tunnel or reinforcement core, hollow or filled, located at or near the top edge or the top rim of the first side-panel. A second side-panel, opposite the first side-panel and generally parallel to the first side-panel, includes a second reinforcement tunnel or reinforcement core, hollow or filled, located at or near the top edge or the top rim of the second side-panel. The two reinforcement tunnels or core contribute to stability and rigidity of the device. An insertable or removable U-shaped handle complements the hollow reinforcement tunnels.

### CROSS-REFERENCE TO RELATED APPLICATIONS

This application claims priority and benefit from U.S. provisional patent application No. 61/751,968, filed on Jan. 14, 2013, which is hereby incorporated by reference in its entirety.

### FIELD OF THE INVENTION

The present invention relates to the field of boxes and containers.

### BACKGROUND

Boxes and containers are used in everyday lives for many years. For example, boxes and receptacles may be used for storage of household items or food, for protecting stored content from rain or moisture, for keeping multiple items in a small and concise form factor, for keeping items locked or out of the reach of third parties, for shipping and transporting of various items, for long-term or short-term storage, or the like.

Some boxes may be manufactured from wood or metal (e.g., a decorative jewelry box), whereas other boxes may be manufactured from paper-based materials or paperboard or cardboard (e.g., a shoe-box). Some boxes may be manufactured from plastic material(s).

### SUMMARY

The present invention may comprise, for example, a box, a toolbox, a container, a respectable, or a cart. The box or container may be formed of plastic material(s), for example, by injection molding. One or more of the top edges of the box may comprise reinforcement tunnels or cores, which may be hollow or filled, and may be located at (or next to) top edge(s) or top rim(s) of the box, thereby reinforcing the box.

For example, a box, container, receptacle, cart, and toolbox include a bottom-side panel and four side-panels. A first side-panel includes a first reinforcement tunnel or reinforcement core, hollow or filled, located at or near the top edge or the top rim of the first side-panel. A second side-panel, opposite the first side-panel and generally parallel to the first side-panel, includes a second reinforcement tunnel or reinforcement core, hollow or filled, located at or near the top edge or the top rim of the second side-panel. The two reinforcement tunnels or core contribute to stability and rigidity of the device. An insertable or removable U-shaped handle complements the hollow reinforcement tunnels. The device may have wheels, locks, and optionally a hole or aperture through which a cable may pass even while the device is closed with a lid or cover.

In accordance with the present invention, for example, a device (e.g., box, container, storage box, receptacle, toolbox, cart) may comprise: a bottom-side panel (110); a right-side panel (111) and a left-side panel (113), wherein the right-side panel (111) is generally perpendicular to the bottom-side panel (110), wherein the left-side panel (113) is generally perpendicular to the bottom-side panel (110), wherein a surface of the right-side panel (111) is substantially identical to a surface of the left-side panel (113); a front-side panel (112) and a rear-side panel (114), wherein the front-side panel (112) is generally perpendicular to the bottom-side panel (110), wherein the rear-side panel (114) is generally perpendicular to the bottom-side panel (110), wherein a surface of the front-side panel (112) is substantially identical to a surface of the rear-side panel (114); wherein the surface of the right-side panel (111) is greater than the surface of the front-side panel (112); wherein the right-side panel (111) comprises a first reinforcement tunnel (131) in proximity to a top rim of the right-side panel (111), wherein the first reinforcement tunnel (131) runs along a top edge of the right-side panel (111); wherein the left-side panel (113) comprises a second reinforcement tunnel (132) in proximity to a top rim of the left-side panel (113), wherein the second reinforcement tunnel (132) runs a top edge of the left-side panel (113).

In some embodiments, the first reinforcement tunnel (131) is filled, and the second reinforcement (132) tunnel is filled. In some embodiments, a cross-section of the first reinforcement tunnel (131) is rectangular, and a cross-section of the second reinforcement tunnel (132) is rectangular.

In some embodiments, the first reinforcement tunnel (131) is hollow, and the second reinforcement (132) tunnel is hollow. In some embodiments, a cross-section of the first reinforcement tunnel (131) is rectangular, and a cross-section of the second reinforcement tunnel (132) is rectangular.

In some embodiments, the device further comprises: a generally U-shaped handle (123) insertable, at least partially, into said first reinforcement tunnel (131) and said second reinforcement tunnel (132).

In some embodiments, the device further comprises: a generally U-shaped handle (123) insertable, at least partially, into friction sleeves (141, 142) located internally within the first reinforcement tunnel (131) and the second reinforcement tunnel (132).

In some embodiments, the device further comprises: a generally U-shaped handle (123) insertable, at least partially, into said first reinforcement tunnel (131) and said second reinforcement tunnel (132); wherein the U-shaped handle (123) is pullable and entirely removable from said device.

In some embodiments, the device further comprises: a first tunnel-cover (151) to close one of two endings of the first reinforcement tunnel (131); a second tunnel-cover (152) to close one of two endings of the second reinforcement tunnel (132).

In some embodiments, the device further comprises: a lid-panel (115) to close over the right-side panel (111), the left-side panel (113), the front-side panel (112), and the rear-side panel (114).

In some embodiments, the lid-panel (115) defines a hole (127) for passing a cable therethrough.

In some embodiments, an edge of the lid-panel (115) defines a first portion of a hole (127); wherein a second portion of said hole (127) is defined by a complementing top edge of one panel out of the right-side panel (111), the left-side panel (113), the front-side panel (112), and the rear-side panel (114).

In some embodiments, the device further comprises: a locking mechanism (125) to lock the lid-panel (115) to at least one panel out of the right-side panel (111), the left-side panel (113), the front-side panel (112), and the rear-side panel (114).

In some embodiments, the device further comprises: at least two wheels connected to the bottom-side panel (110); and the device may be a cart or mobile cart of wheeled cart.

In some embodiments, the device may be a toolbox, for example, a 50-gallon toolbox.

In some embodiments, the bottom-side panel (110), the right-side panel (111), the left-side panel (113), the front-side panel (112), the rear-side panel (114), the first reinforcement tunnel (131), and the second reinforcement tunnel (132) are formed of plastic.

In some embodiments, the bottom-side panel (110), the right-side panel (111), the left-side panel (113), the front-side panel (112), the rear-side panel (114), the first reinforcement tunnel (131), and the second reinforcement tunnel (132) are formed of injection molded plastic material.

In some embodiments, the bottom-side panel (110), the right-side panel (111), the left-side panel (113), the front-side panel (112), the rear-side panel (114), the first reinforcement tunnel (131), and the second reinforcement tunnel (132) are formed in a single process of injection molding of plastic material.

In some embodiments, the bottom-side panel (110), the right-side panel (111), the left-side panel (113), the front-side panel (112), the rear-side panel (114), the first reinforcement tunnel (131), and the second reinforcement tunnel (132) are non-detachable of each other and are formed in a single process of injection molding of plastic material.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIGS. 1-2 are schematic illustrations of perspective views of a box, in accordance with some demonstrative embodiments of the present invention;

FIGS. 3-4 are cross-section views of the box as if it was cut in third or in half, and particularly showing the rectangular cross sections of the hollow reinforcement channels, in accordance with some demonstrative embodiments of the present invention;

FIG. 5 is a schematic illustration of the box as if it was cut vertically exactly within the right-side reinforcement tunnel, and particularly showing portion of the handle being partially inserted into the hollow reinforcement tunnels, in accordance with some demonstrative embodiments of the present invention;

FIG. 6 is a right-side view of the box, in accordance with some demonstrative embodiments of the present invention;

FIG. 7 is a left-side view of the box, in accordance with some demonstrative embodiments of the present invention;

FIG. 8 is a rear-side view of the box, in accordance with some demonstrative embodiments of the present invention;

FIG. 9 is a front-side view of the box, in accordance with some demonstrative embodiments of the present invention;

FIG. 10 is a bottom-side view of the box, in accordance with some demonstrative embodiments of the present invention;

FIG. 11 is a top-side view of the box, in accordance with some demonstrative embodiments of the present invention;

FIG. 12 is a schematic illustration of a perspective view of the box with the lid being open, and with the handle being fully extended outwardly, in accordance with some demonstrative embodiments of the present invention;

FIG. 13 is a schematic illustration of a perspective view of the box with the lid being open, and with the handle being partially extended outwardly, in accordance with some demonstrative embodiments of the present invention;

FIG. 14 is a schematic illustration of a perspective view of the box with the lid being closed, and with the handle shown entirely externally to the box, in accordance with some demonstrative embodiments of the present invention;

FIG. 15 is a schematic illustration of a perspective view of the box as if it was cut horizontally exactly within the reinforcement tunnels, and showing the handle in an extended position, in accordance with some demonstrative embodiments of the present invention;

FIG. 16 is a schematic illustration of a perspective view of the box as if it was cut horizontally exactly within the reinforcement tunnels, and showing the handle in a fully inserted position, in accordance with some demonstrative embodiments of the present invention;

FIG. 17 is a schematic illustration of a portion of the box (in a closed position) as if it was cut vertically exactly within the right-side reinforcement tunnel, and showing a portion of the handle being extended outwardly from the hollow reinforcement tunnel, in accordance with some demonstrative embodiments of the present invention;

FIG. 18 is a schematic illustration of a portion of the box (in a closed position) as if it was cut vertically exactly within the right-side reinforcement tunnel, and showing a portion of the handle being fully inserted into the hollow reinforcement tunnel, in accordance with some demonstrative embodiments of the present invention;

FIGS. 19-20 are schematic illustrations of a portion of the box (in a closed position), showing hole(s) in between the lid and a side panel, as well as an electric cable passing through one of the holes, in accordance with some demonstrative embodiments of the present invention.

### DETAILED DESCRIPTION OF THE PRESENT INVENTION

In the following detailed description, numerous specific details are set forth in order to provide a thorough understanding of some embodiments. However, it may be understood by persons of ordinary skill in the art that some embodiments may be practiced without these specific details. In other instances, well-known methods, procedures, components, units and/or circuits have not been described in detail so as not to obscure the discussion.

The present invention may include, for example, a box, a container, a storage box, a storage container, a toolbox, a cart, a mobile or portable box or container or toolbox or cart, a wheeled or partially-wheeled or non-wheeled box or container or toolbox or cart, a 50-gallon box or container or receptacle or cart, or other suitable type or size of container(s), which may be referred to herein as a “box”.

The box may be formed of plastic, for example, of injection molding of one or more raw plastic material(s). In some embodiments, the entire box (or multiple features of the box that are describe herein) may be injected in one injection, as a mono-block plastic item; and optionally, the wheels, handle, and lid of the box may be separately injected and then assembled. Optionally, the box may be formed of plastic and/or other materials, for example, metal, wood, or the like.

The box may include two wheels (e.g., front-side wheels, rear-side wheels, side-wheels), to allow wheeling or pushing/pulling of the box; or four wheels; or three wheels (e.g., two rear-side wheels and one central front-side wheel); or no wheels. The box may optionally include one or more handles, or a U-shaped handle, which may be located at one top edge of the box, to facilitate such pushing or pulling or wheeling or lifting of the box.

In some embodiments of the present invention, the box may be an open box and may not include a cover or lid. In other embodiments of the present invention, the box may include a cover or lid which may be attached to the box and removed from the box, for example, using a snapping mechanism. In other embodiments of the present invention, the cover or lid may rotate around an axis or one or more hinge(s), allowing a user to open the cover or lid while keeping the lid or cover connected or attached to the box itself.

The box may include a reinforcing mechanism or a support mechanism, which may increase the strength and/or durability and/or rigidness of the box, particular the top area of the box.

In some embodiments of the present invention, one edge, or two edges, or three edges, or four edges of the box, particularly edge(s) located at the top area of the box, may include reinforcing cores or tunnels or reinforcing tunnels. In a demonstrative example, the two longer edges, parallel to each other, out of the four top edges of the box, may include two (respective) reinforcing tunnels.

A reinforcing tunnel may be, for example, a generally-hollow tunnel or core or horizontal-pillar, which may run in proximity to (or under, or beneath, or to the side of) a rim or edge of the box. The reinforcing tunnel may include three sides (e.g., having triangular cross-section), four sides (e.g., having square-shaped or rectangular cross-section), other number of sides, or other shape (e.g., oval or circular cross-section). In a demonstrative example, the two longer edges of the top of the box, may include two (respective) reinforcing tunnels, each reinforcing tunnel having a generally rectangular cross-section.

The reinforcing tunnels may optionally be, or may include, a double-walled hollow tunnel, providing rigidness and stiffness to an edge or rim of the box, particularly to edges or rims that are located at the top portion of the box which may receive a cover or lid. In some embodiments of the invention, reinforcing tunnels may be included only at (or near, or beneath) the upper edges or the upper rims of the box (or, two out of the four upper edges of the box), and may not be included at (or near) the lower edges of the box (which touch the ground).

In some embodiments of the present invention, the rectangular cross-section of the reinforcing tunnel may be a rectangle having a longer dimension generally vertical, or generally perpendicular to the ground, or generally perpendicular to the longer dimension of the box; such that the rectangular cross-section of the reinforcing tunnel may be a rectangle elongated downward from the top edge(s) of the box towards the ground. In other embodiments, the rectangular cross-section of the reinforcing tunnel may be a rectangle having a shorter dimension generally vertical, or generally perpendicular to the ground, or generally perpendicular to the longer dimension of the box; such that the rectangular cross-section of the reinforcing tunnel may be a rectangle elongated sideways, horizontally away from the top edge(s) of the box. Other suitable shapes may be used for the cross-section of the reinforcing tunnel.

The reinforcing tunnel may run parallel to a top edge of the box; for example, running approximately 100 percent or 95 percent or 90 percent (or at least 90 percent) of the total length of the longer dimension of the box.

In some embodiments of the present invention, an end of a reinforcing tunnel may remain open and hollow. In other embodiments, an end of a reinforcing tunnel may be covered with a small tunnel-cover or lid, or, the reinforcing tunnel may be pre-manufactured to be hollow inside but to end with an injected or attached cover or lid. In other embodiments, reinforcing tunnel(s) may be used to store therein part of a handle (e.g., a U-shaped handle) which may be inserted into the reinforcing tunnel(s) and/or pulled from the reinforcing tunnel(s). The reinforcing tunnel(s) may thus provide rigidity and stiffness to the box, and may also allow efficient storage of a collapsible and/or retracting handle.

In some embodiments of the present invention, the box may include an outlet or accessible point or a defined aperture, allowing to pass through it an electric cable or electric cord, while still preventing wetness or water or dust to enter into the box. Optionally, the outlet or aperture may be located at (or near) a top edge of the box. Optionally, one half (or one portion) of the outlet may be located at a top edge or near a top portion of a side-panel of the box; whereas another half (or another portion) of the outlet may be located at the cover of the box, or particularly at an edge or rim of the cover which wraps around a top portion of the box or which connects to the top area of the box. Other suitable locations or structures may be used.

In some embodiments of the present invention, the cover and/or the box may include one or more snaps or snapping elements, or male-female elements, or other suitable connectors, allowing a user to close or shut the cover onto the box. Optionally, the cover and/or the box may include a locking element or a pin or other suitable element, allowing to snap-and-lock the cover onto the box, in one step or in two steps.

The present invention may include a method or process of using a box or container. The method may include, for example, opening the cover by removing the cover from the box (or by rotating the cover by utilizing an axis or connecting hinges); storing tools or items inside the box; optionally, placing an electric cable at the outlet at a side of the container; and closing the cover of the box (e.g., by using a snap-and-lock mechanism or other suitable latching mechanism). Optionally, the method may include pulling a handle out of hollow reinforcing tunnel(s), or, pushing a handle into hollow reinforcing tunnel(s).

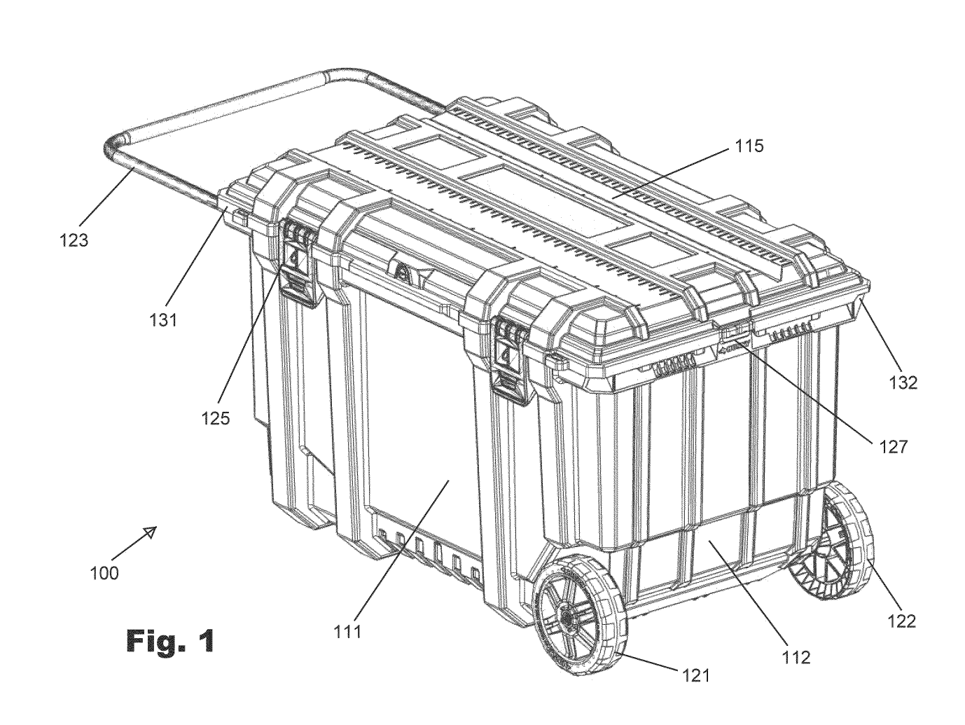

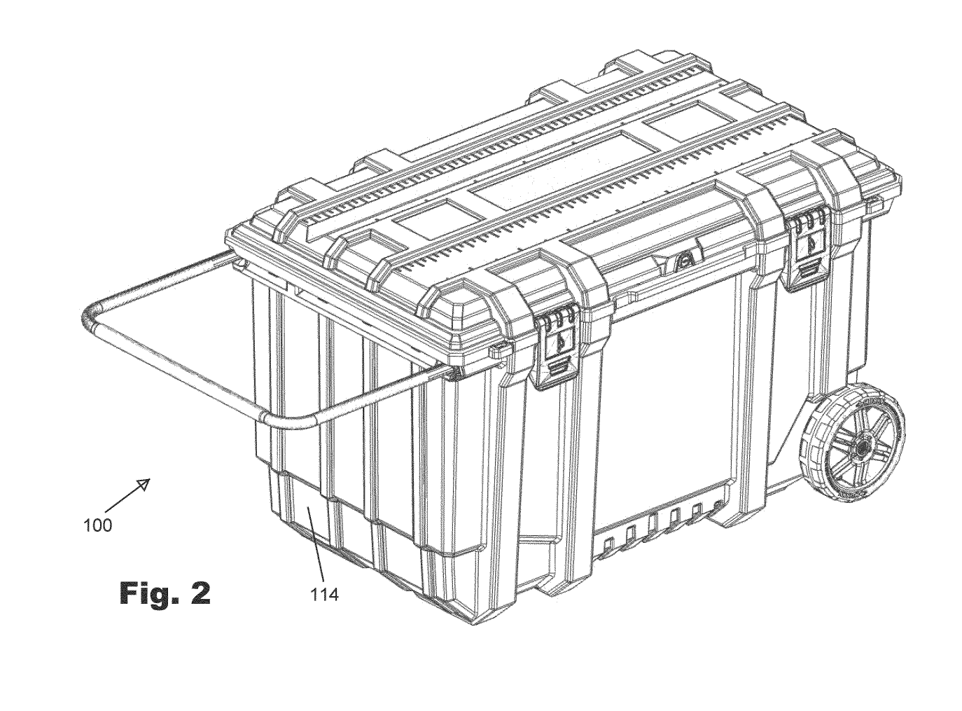

Reference is made to FIGS. 1-2, which are schematic illustrations of perspective views of a box 100 in accordance with some demonstrative embodiments of the present invention. Box 100 may comprise a bottom panel 110, four side panels 111-114, and a top panel or cover or lid 115.

Two (front-side) wheels 121-122 are shown, for demonstrative purposes; and a U-shaped handle 123 may optionally be connected or attached, for example, at a side opposite the wheels 121-122.

Two reinforcement tunnels 131-132 are shown, at opposing top edges or top rims of box 100; although in other implementations, one or three or four reinforcement tunnels may be used.

Optionally, one or more locking mechanisms 125 may be used, allowing a user to insert a lock or a padlock into a U-shaped or ring-shaped element, thereby attaching or locking the lid 115 to one of the side panels (e.g., to side panel 111).

Optionally, one or more of side-panels 111-114, and/or the lid 115, may comprise a small aperture or hole 127 (e.g., having a diameter of approximately 5 or 10 or 15 millimeters), or a series or batch of such holes (e.g., to or three such holes, in proximity to each other); in order to allow a user to pass a wire or cable (e.g., electric cable) through hole 127. This may allow, for example, to store heavy machinery or tool within box 100, and to keep the lid 115 covered and the box 100 closed; while also allowing the wire or cable to extend out of box 110, for example, in order to electrically charge a tool stored within box 100 while box 100 is in closed position; and thereby obviating the need to open the lid 115 in order to charge the tool, or the need to remove the tool from within the box 100 in order to charge the tool, or the like. Hole 127 may be utilized for other purposes, and not necessarily for electrical charging. Optionally, hole 127 may be implemented such that a first half (or a first portion) of the hole is located in side panel 112, whereas a second half (or a second portion), which complements the first half (or portion), is located in the lid 115.

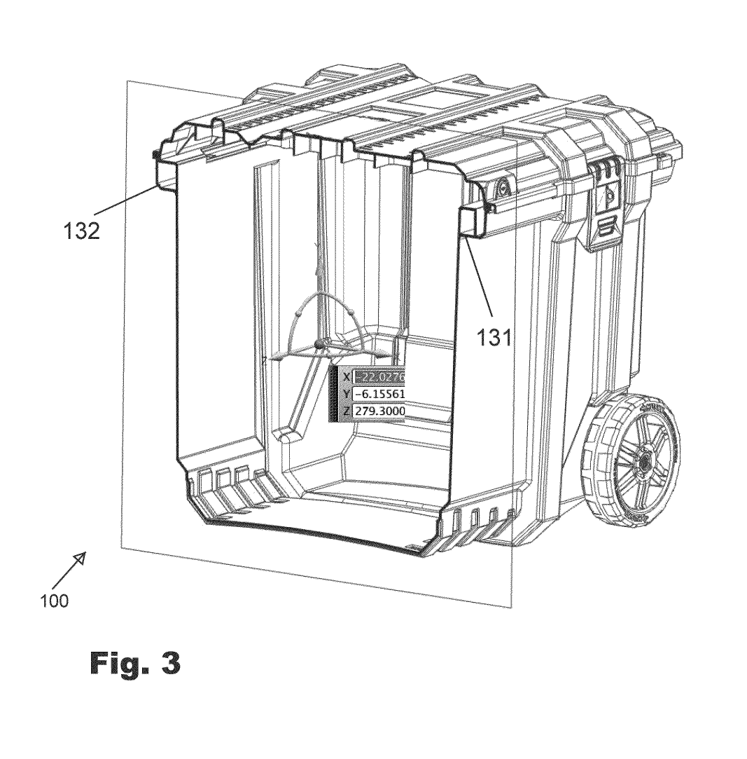

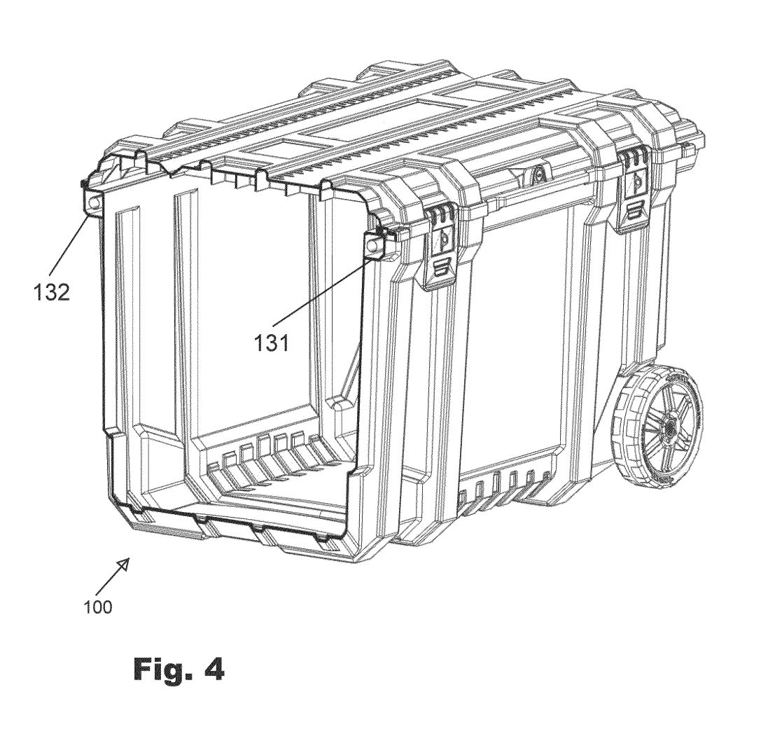

Reference is made to FIGS. 3-4, which are cross-section views of box 100 as if it was cut in third or in half, and particularly showing the rectangular cross sections of hollow reinforcement channels 131-132.

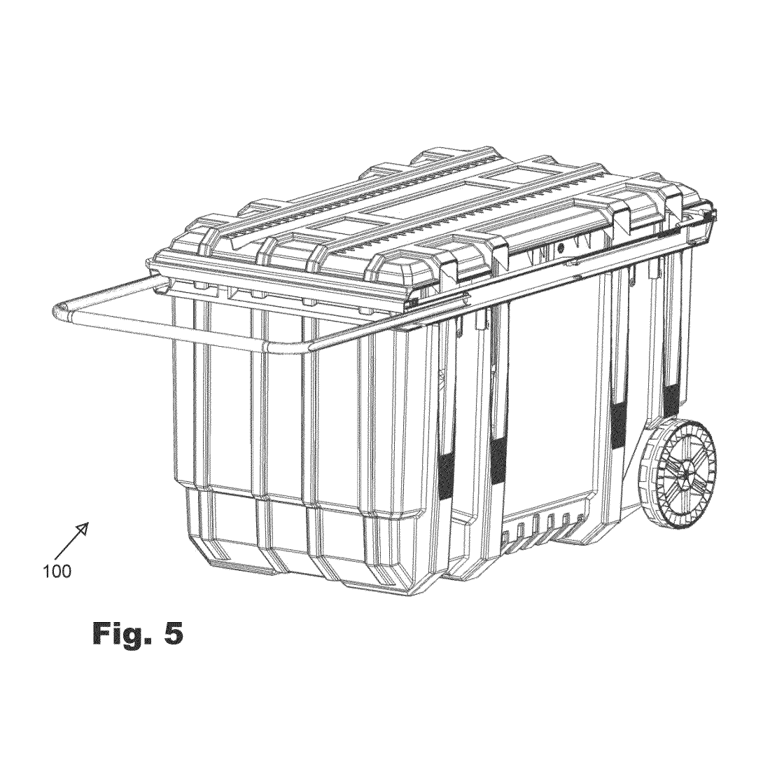

Reference is made to FIG. 5, which is a schematic illustration of box 100 as if it was cut vertically exactly within the reinforcement tunnel 131, and particularly showing portion of handle 123 being partially inserted into hollow reinforcement tunnels 131-132.

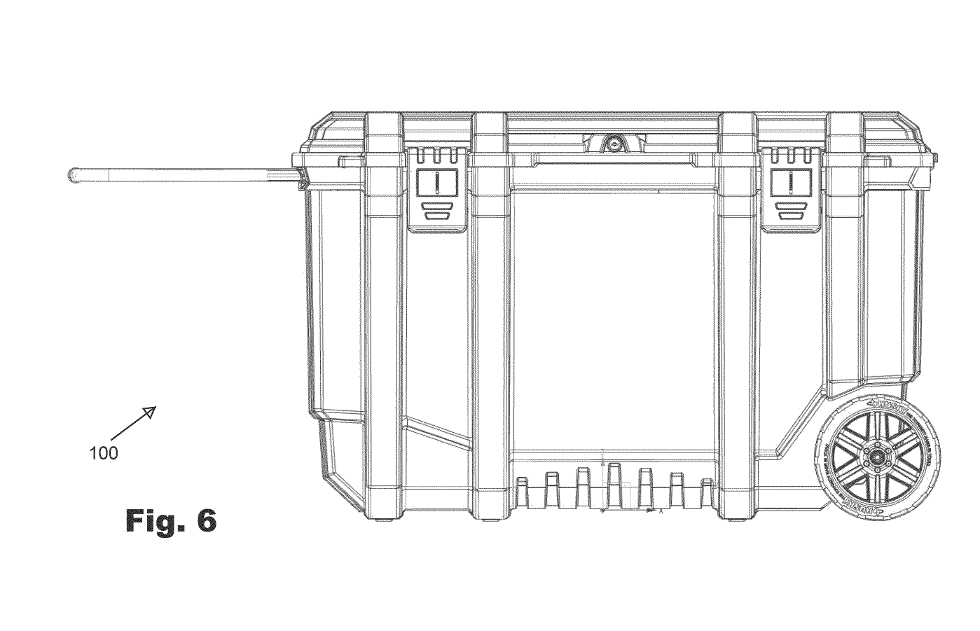

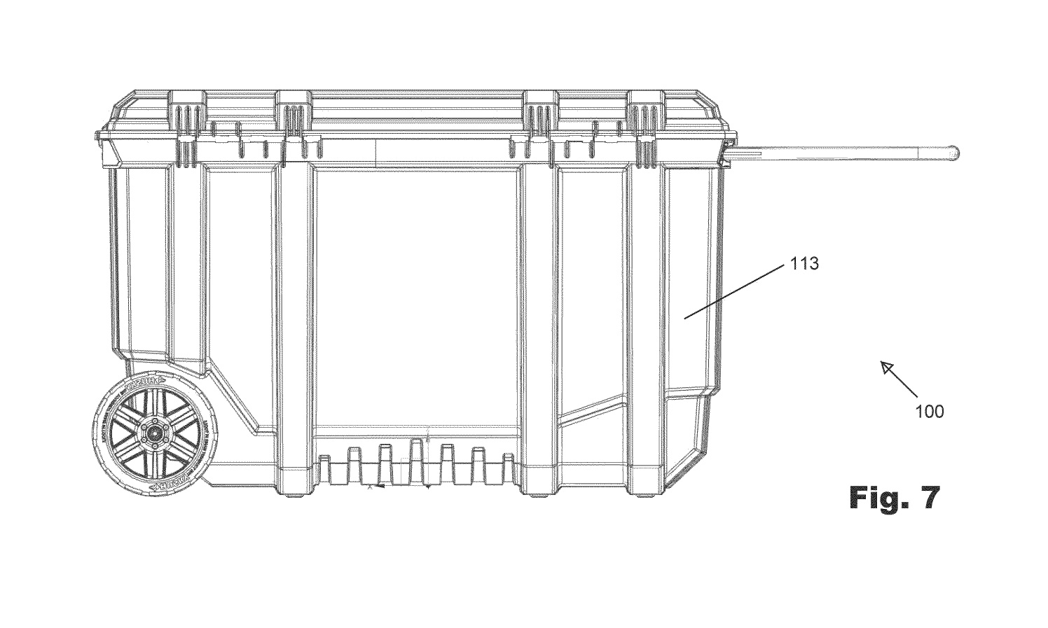

Reference is made to FIG. 6, which is a right-side view of box 100; and to FIG. 7, which is a left-side view of box 100.

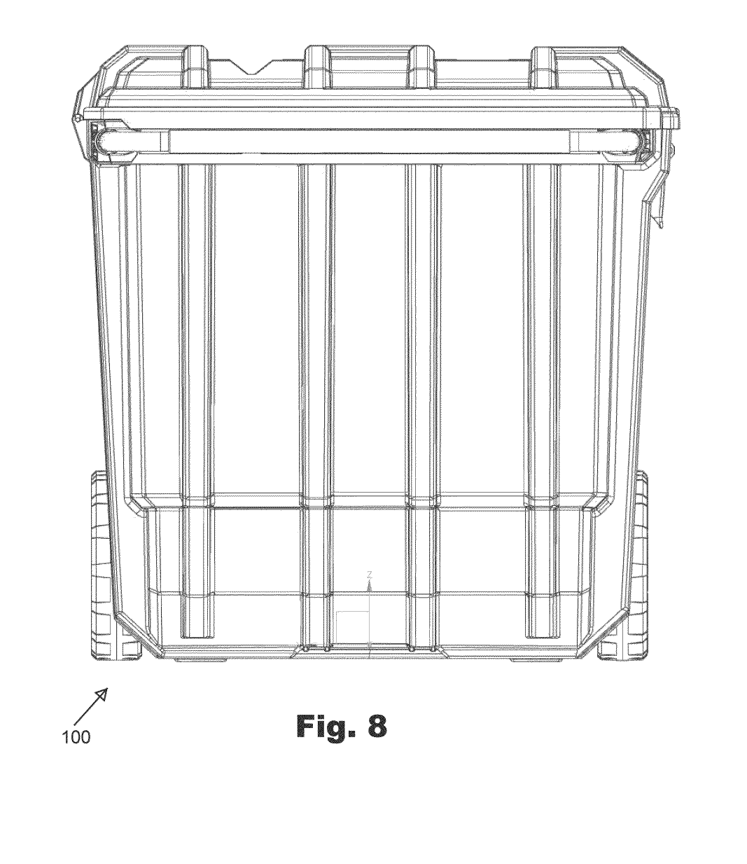

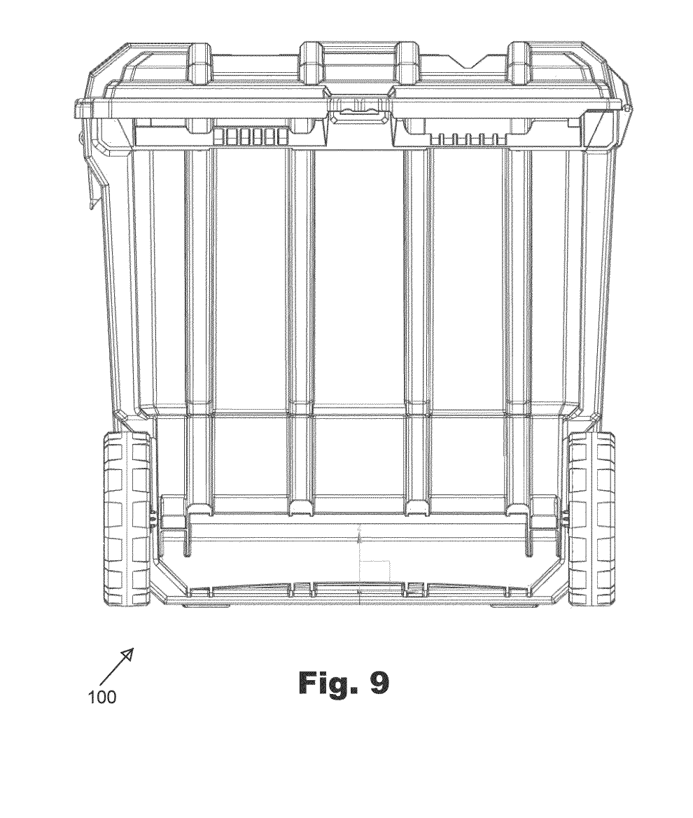

Reference is made to FIG. 8, which is a rear-side view of box 100; and to FIG. 9, which is a front-side view of box 100.

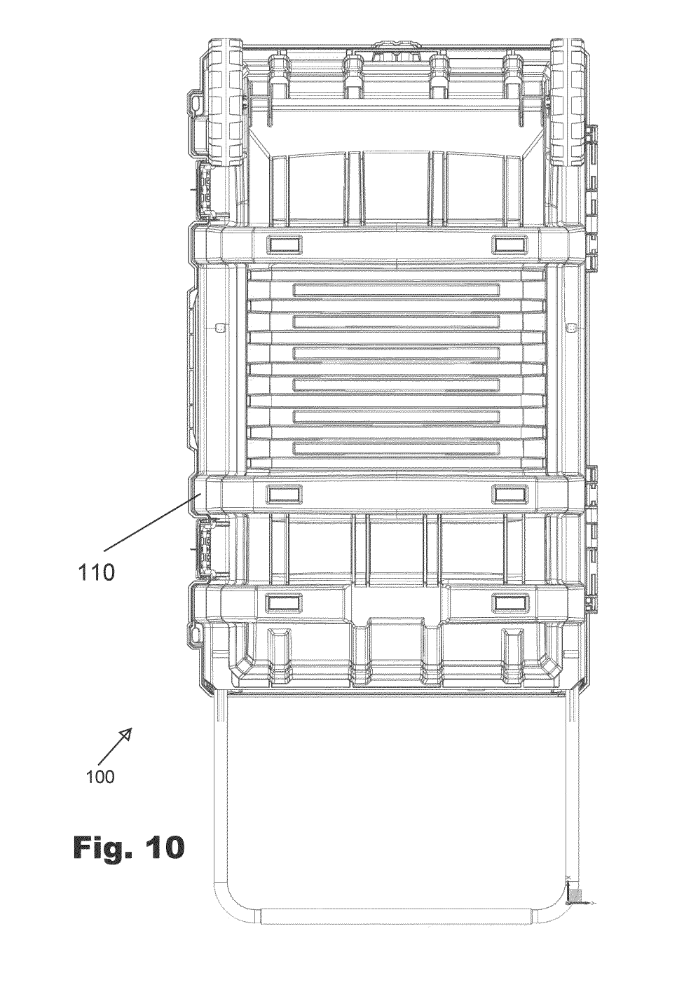

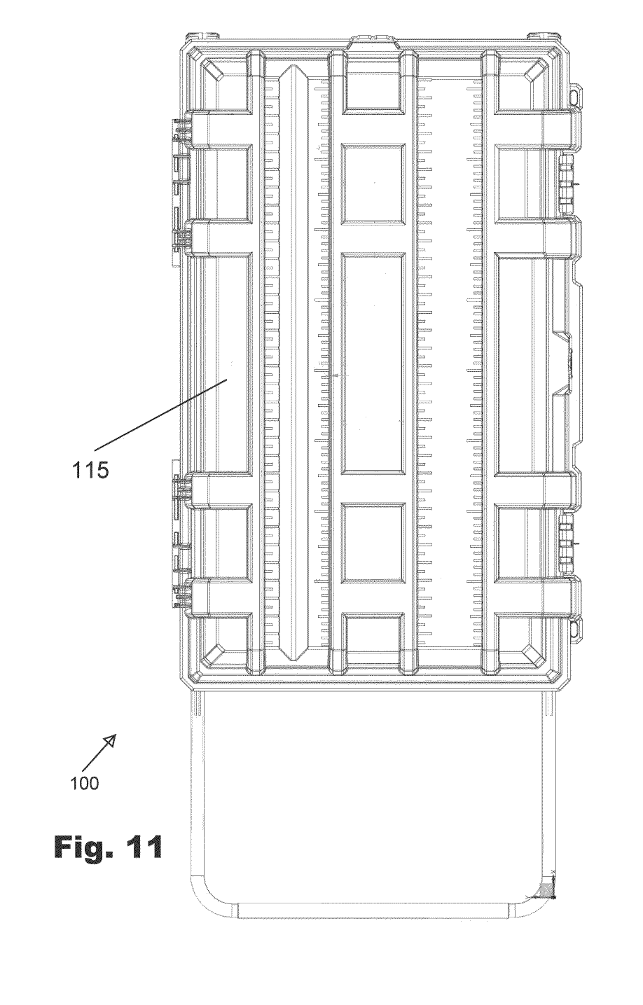

Reference is made to FIG. 10, which is a bottom-side view of box 100; and to FIG. 11, which is a top-side view of box 100.

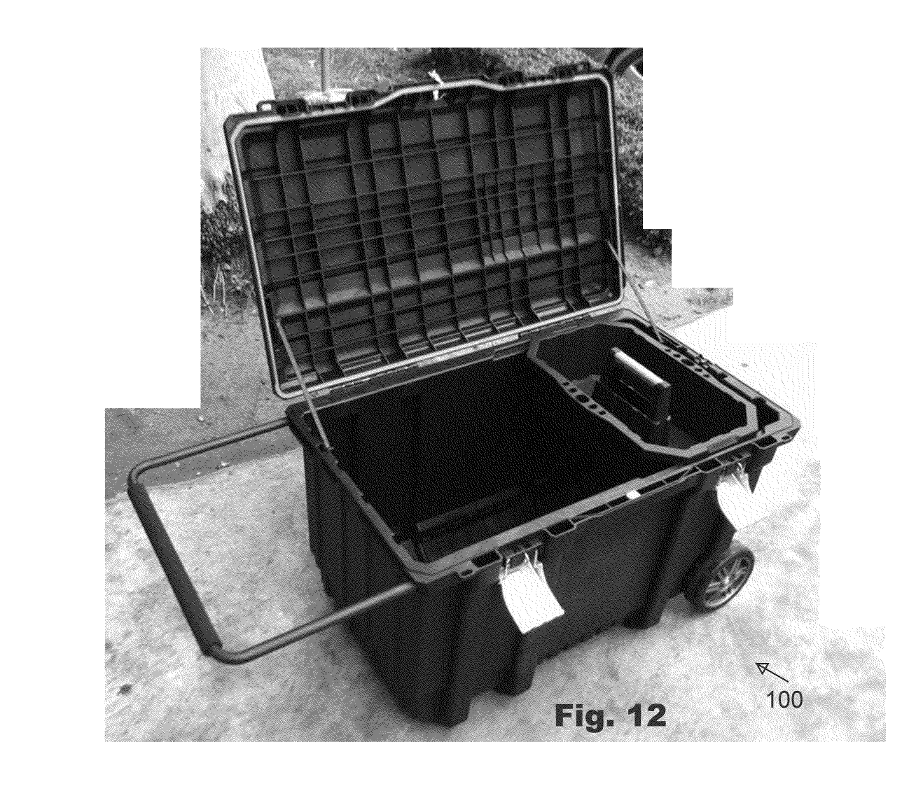

Reference is made to FIG. 12, which is a schematic illustration of a perspective view of box 100 with the lid 115 being open, and with the handle 123 being fully extended outwardly.

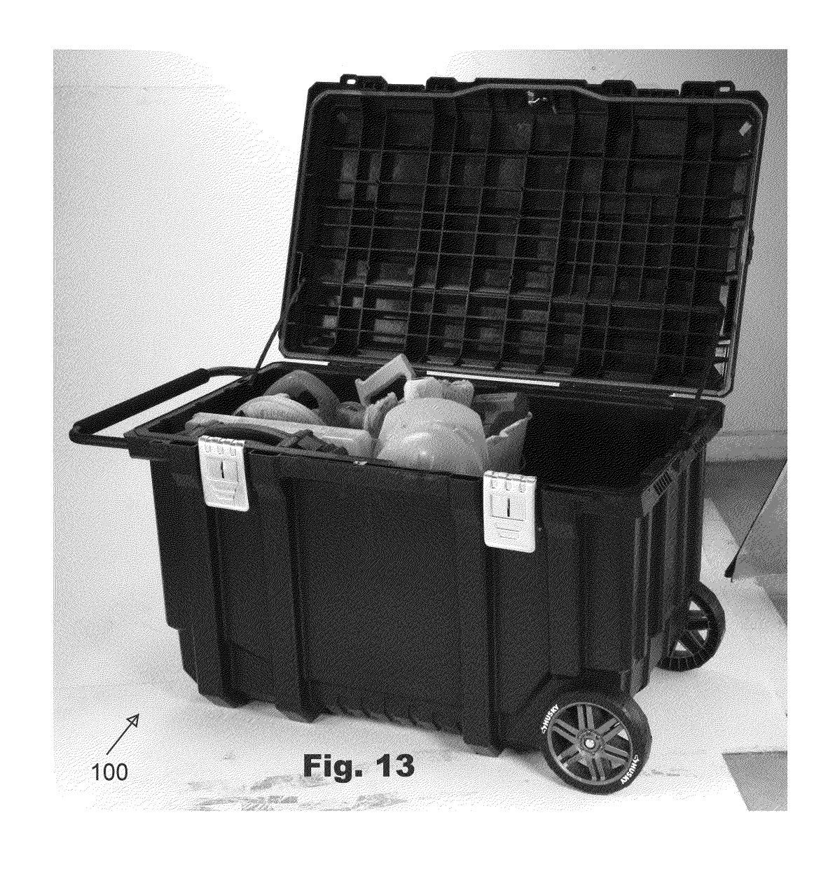

Reference is made to FIG. 13, which is a schematic illustration of a perspective view of box 100 with the lid 115 being open, and with the handle 123 being partially extended outwardly.

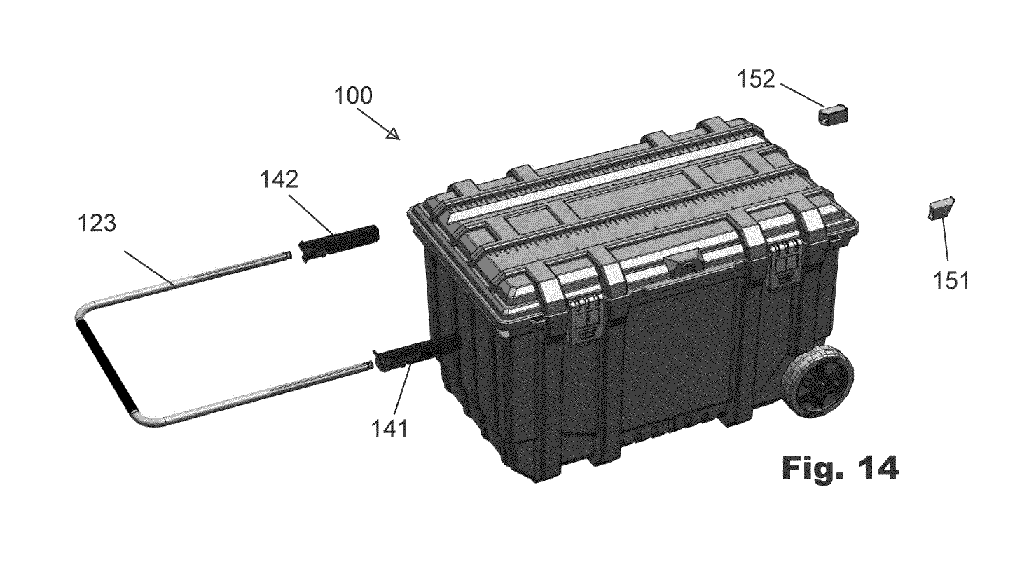

Reference is made to FIG. 14, which is a schematic illustration of a perspective view of box 100 with the lid 115 being closed. Handle 123 is shown entirely externally to box 100, and further shown are two internal sleeves 141-142 which may be contained inside the reinforcement channels 131-132 (respectively) and may hold the handle 123 in place, or may provide friction against handle 123 to allow gradual insertion or removal of handle 123. Further shown are two tunnel-covers 151-152, which may be used, optionally, to cover or close the hollow reinforcement tunnels 131-132 (respectively), for example, to prevent entrance of water or moisture or dirt therein.

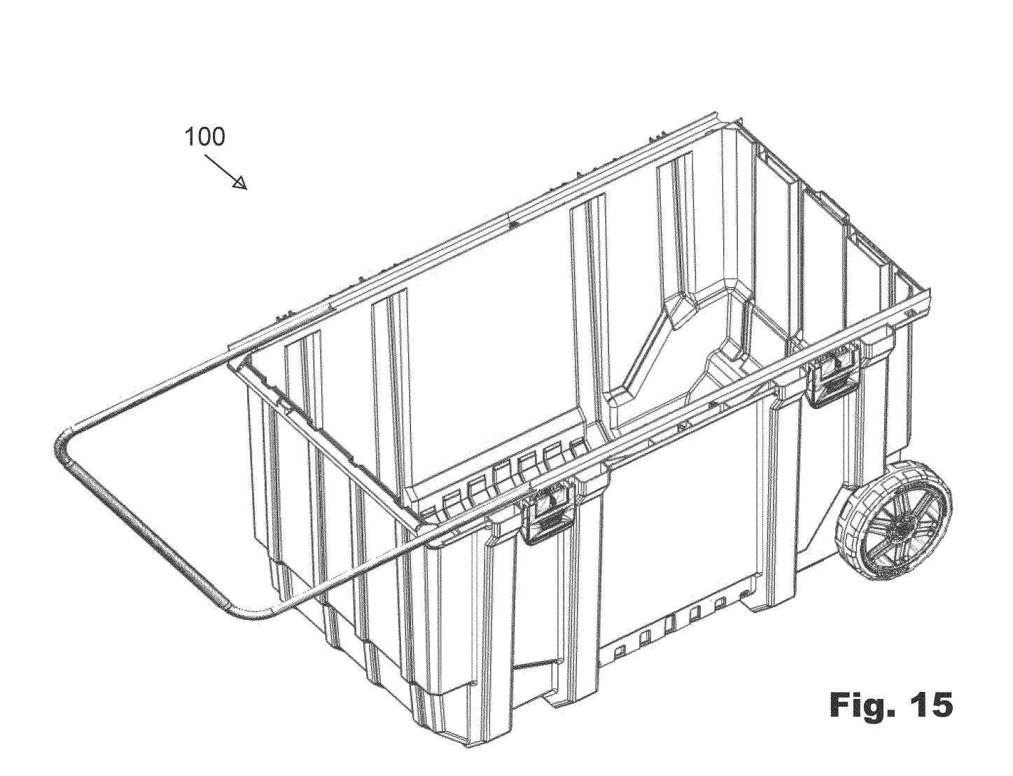

Reference is made to FIG. 15, which is a schematic illustration of a perspective view of box 100 as if it was cut horizontally exactly within the reinforcement tunnels 131-132, and showing handle 123 in an extended position.

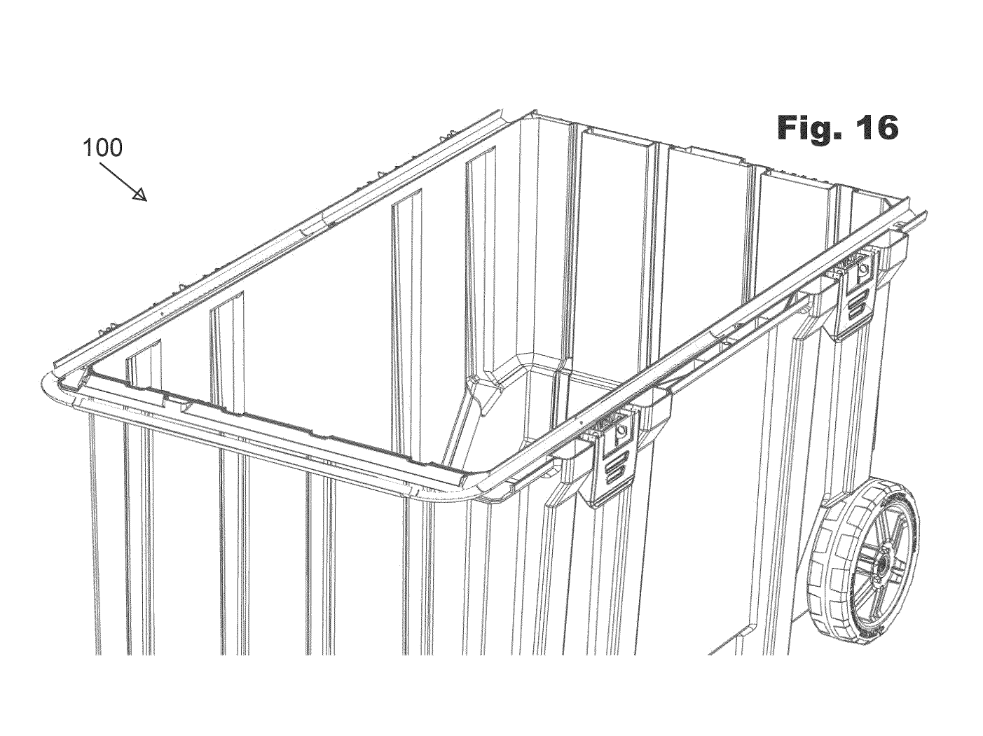

Reference is made to FIG. 16, which is a schematic illustration of a perspective view of box 100 as if it was cut horizontally exactly within the reinforcement tunnels 131-132, and showing handle 123 in a fully inserted position.

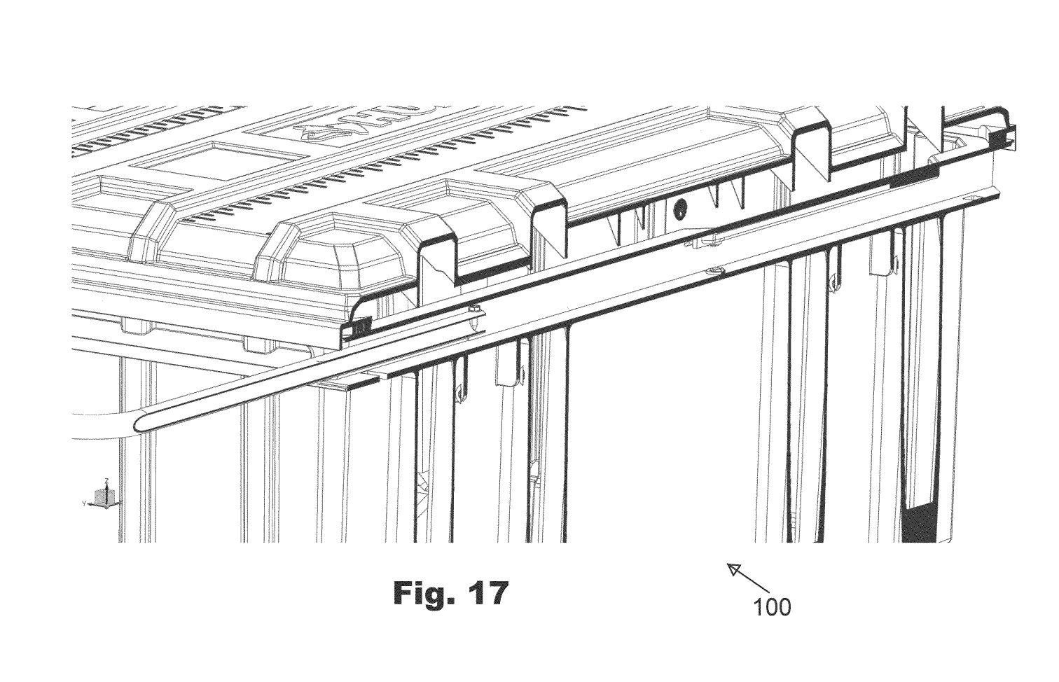

Reference is made to FIG. 17, which is a schematic illustration of a portion of box 100 (in a closed position) as if it was cut vertically exactly within the reinforcement tunnel 131, and showing a portion of handle 123 being extended outwardly from hollow reinforcement tunnel 131.

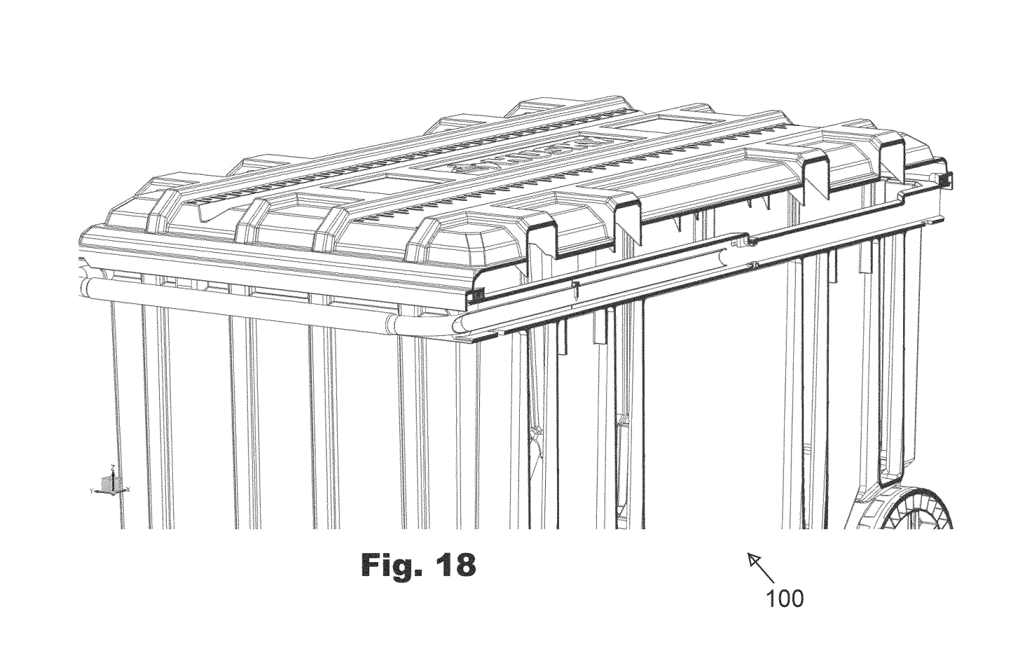

Reference is made to FIG. 18, which is a schematic illustration of a portion of box 100 (in a closed position) as if it was cut vertically exactly within the reinforcement tunnel 131, and showing a portion of handle 123 being fully inserted into hollow reinforcement tunnel 131.

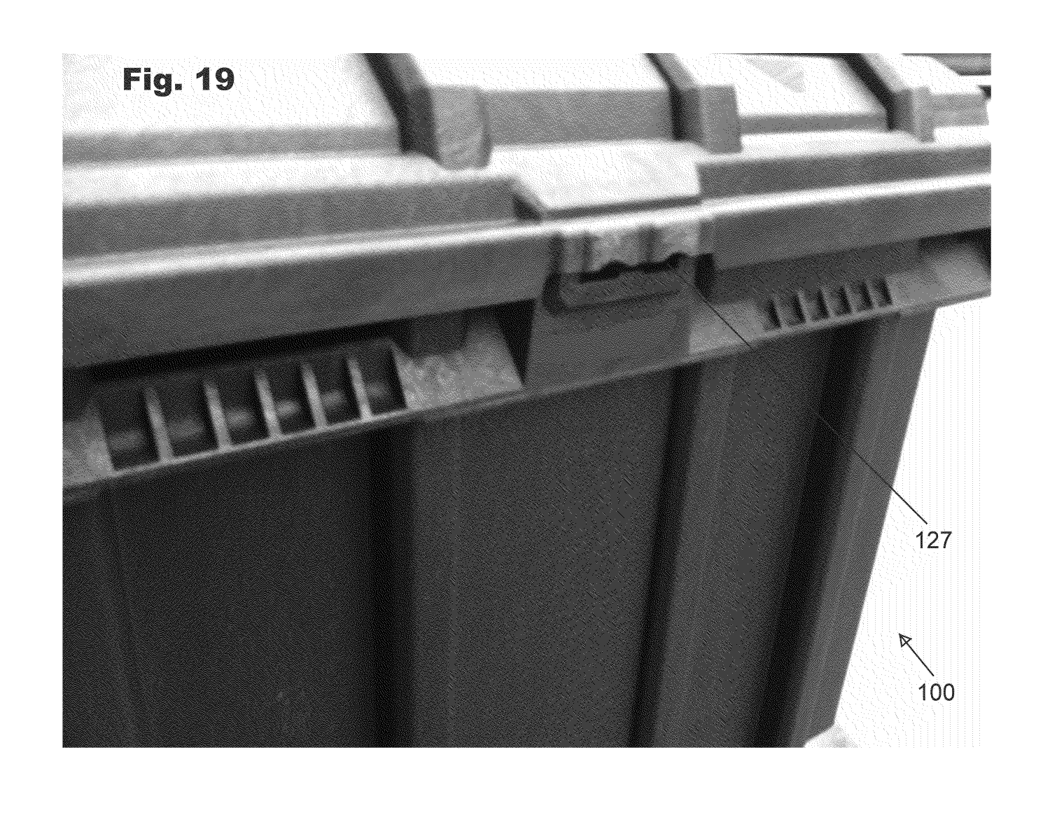

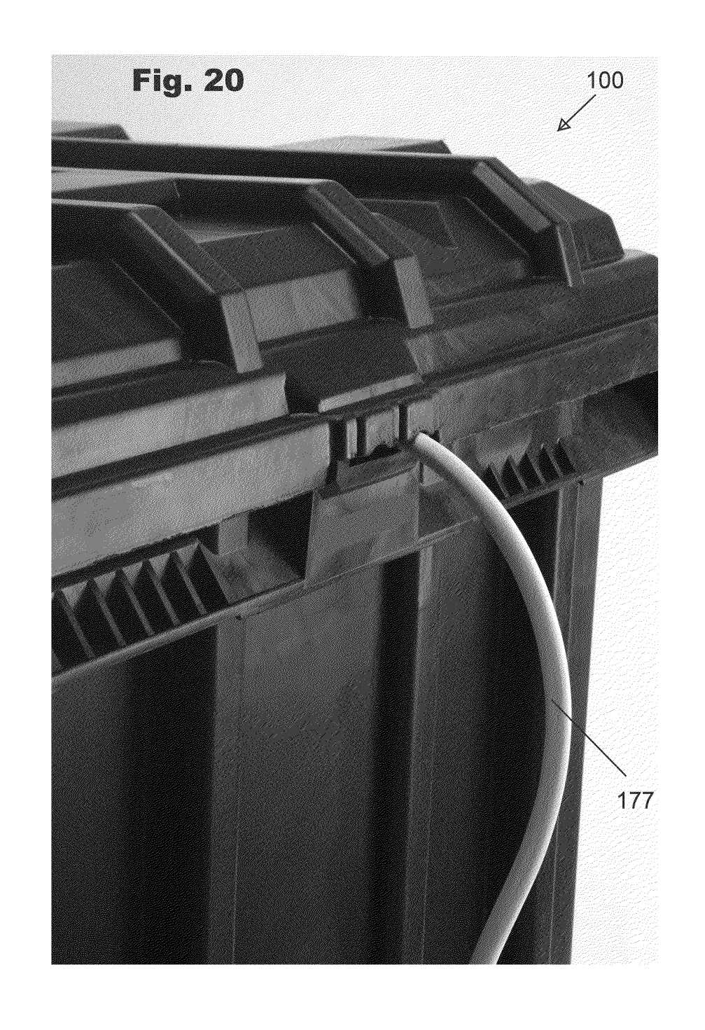

Reference is made to FIGS. 19-20, which are schematic illustration of a portion of box 100 (in a closed position) showing hole(s) 127 in between the lid 115 and the side panel 112, and further showing an electric cable 177 passing through one of the holes 127.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A device comprising:
a bottom-side panel (110);
a right-side panel (111) and a left-side panel (113), wherein the right-side panel (111) is generally perpendicular to the bottom-side panel (110), wherein the left-side panel (113) is generally perpendicular to the bottom-side panel (110), wherein a surface of the right-side panel (111) is substantially identical to a surface of the left-side panel (113);
a front-side panel (112) and a rear-side panel (114), wherein the front-side panel (112) is generally perpendicular to the bottom-side panel (110), wherein the rear-side panel (114) is generally perpendicular to the bottom-side panel (110), wherein a surface of the front-side panel (112) is substantially identical to a surface of the rear-side panel (114);
wherein the surface of the right-side panel (111) is greater than the surface of the front-side panel (112);
wherein the right-side panel (111) comprises a first reinforcement tunnel (131) in proximity to a top rim of the right-side panel (111), wherein the first reinforcement tunnel (131) runs along a top edge of the right-side panel (111);
wherein the left-side panel (113) comprises a second reinforcement tunnel (132) in proximity to a top rim of the left-side panel (113), wherein the second reinforcement tunnel (132) runs a top edge of the left-side panel (113).

2. The device of claim 1, wherein the first reinforcement tunnel (131) is filled, and wherein the second reinforcement (132) tunnel is filled.

3. The device of claim 2, wherein a cross-section of the first reinforcement tunnel (131) is rectangular, and wherein a cross-section of the second reinforcement tunnel (132) is rectangular.

4. The device of claim 1, wherein the first reinforcement tunnel (131) is hollow, and wherein the second reinforcement (132) tunnel is hollow.

5. The device of claim 4, wherein a cross-section of the first reinforcement tunnel (131) is rectangular, and wherein a cross-section of the second reinforcement tunnel (132) is rectangular.

6. The device of claim 4, further comprising:
a generally U-shaped handle (123) insertable, at least partially, into said first reinforcement tunnel (131) and said second reinforcement tunnel (132).

7. The device of claim 4, further comprising:
a generally U-shaped handle (123) insertable, at least partially, into friction sleeves (141, 142) located internally within the first reinforcement tunnel (131) and the second reinforcement tunnel (132).

8. The device of claim 4, further comprising:
a generally U-shaped handle (123) insertable, at least partially, into said first reinforcement tunnel (131) and said second reinforcement tunnel (132); wherein the U-shaped handle (123) is pullable and entirely removable from said device.

9. The device of claim 4, further comprising:
a first tunnel-cover (151) to close one of two endings of the first reinforcement tunnel (131);
a second tunnel-cover (152) to close one of two endings of the second reinforcement tunnel (132).

10. The device of claim 1, further comprising:
a lid-panel (115) to close over the right-side panel (111), the left-side panel (113), the front-side panel (112), and the rear-side panel (114).

11. The device of claim 10, wherein the lid-panel (115) defines a hole (127) for passing a cable therethrough.

12. The device of claim 10, wherein an edge of the lid-panel (115) defines a first portion of a hole (127); wherein a second portion of said hole (127) is defined by a complementing top edge of one panel out of the right-side panel (111), the left-side panel (113), the front-side panel (112), and the rear-side panel (114).

13. The device of claim 10, further comprising:
A locking mechanism (125) to lock the lid-panel (115) to at least one panel out of the right-side panel (111), the left-side panel (113), the front-side panel (112), and the rear-side panel (114).

14. The device of claim 1, further comprising:
at least two wheels connected to the bottom-side panel (110);
wherein the device is a cart.

15. The device of claim 1, wherein the device is a toolbox.

16. The device of claim 1, wherein the device is a 50-gallon toolbox.

17. The device of claim 1, wherein the bottom-side panel (110), the right-side panel (111), the left-side panel (113), the front-side panel (112), the rear-side panel (114), the first reinforcement tunnel (131), and the second reinforcement tunnel (132) are formed of plastic.

18. The device of claim 1, wherein the bottom-side panel (110), the right-side panel (111), the left-side panel (113), the front-side panel (112), the rear-side panel (114), the first reinforcement tunnel (131), and the second reinforcement tunnel (132) are formed of injection molded plastic material.

19. The device of claim 1, wherein the bottom-side panel (110), the right-side panel (111), the left-side panel (113), the front-side panel (112), the rear-side panel (114), the first reinforcement tunnel (131), and the second reinforcement tunnel (132) are formed in a single process of injection molding of plastic material.

20. The device of claim 1, wherein the bottom-side panel (110), the right-side panel (111), the left-side panel (113), the front-side panel (112), the rear-side panel (114), the first reinforcement tunnel (131), and the second reinforcement tunnel (132) are non-detachable of each other and are formed in a single process of injection molding of plastic material.
